(19) United States
(12) Patent Application Publication
(10) Pub. No.: US 2026/0343702 A1
(43) Pub. Date: Oct. 29, 2026

(54) LED DIMMING CIRCUIT, MULTI-CHANNEL LED DIMMING SYSTEM, AND DISPLAY DEVICE

(71) Applicant: Joulwatt Technology (Shenzhen) Co., Ltd., Shenzhen City (CN)

(72) Inventors: Shengfeng LI, Shenzhen (CN); Duo LI, Hangzhou (CN)

(21) Appl. No.: 19/658,383

(22) Filed: Apr. 24, 2026

(30) Foreign Application Priority Data
Apr. 25, 2025 (CN) 202510533698.1

(51) Int. Cl. H05B 45/325; H05B 45/14; H05B 45/3725; H05B 45/48

(52) U.S. Cl. CPC H05B 45/325; H05B 45/14; H05B 45/3725; H05B 45/48

(57) ABSTRACT

Disclosed are an LED dimming circuit, a multi-channel LED dimming system, a display device. The LED dimming circuit is connected to an LED string and includes parallel dimming branches and an operational amplifier with an input receiving a reference voltage. Each dimming branch includes a switch unit, a first transistor, and a first resistor connected to the first transistor at a common node connected to another input of the operational amplifier through the switch unit. A control terminal of the first transistor is connected to an output of the operational amplifier through the switch unit. When the switch unit turns on, the corresponding dimming branch is in on state. By controlling on/off states of the dimming branches, the LED string current is adjusted. The switch unit outside the current path avoids introducing switch resistance. Different brightness levels, small area, high dimming accuracy, low error, and wide dimming range are achieved.

### CROSS-REFERENCE TO PRIOR APPLICATIONS

The present application claims priority to Chinese Patent Application No. 2025105336981, filed on Apr. 25, 2025, entitled “LED DIMMING CIRCUIT, MULTI-CHANNEL LED DIMMING SYSTEM, AND DISPLAY DEVICE”, the entire content of which is incorporated herein by reference, including the full text of the specification, claims, drawings, and abstract.

### TECHNICAL FIELD

The present application relates to a field of LED display technology, specifically to an LED dimming circuit, a multi-channel LED dimming system, and a display device.

### BACKGROUND

With the development of semiconductor light-emitting diode (LED) technology, LED lighting is widely used in various lighting scenarios. LED linear dimming is a common function of LED lighting, and the essence of LED linear dimming is to change the light emission intensity of an LED emitter. Most lighting scenarios require LEDs to have a dimming function to achieve energy saving and meet customized lighting needs.

FIG. 1 shows a schematic circuit diagram of an LED dimming circuit in the prior art. As shown in FIG. 1, a transistor M0 is connected to the cathode of an LED string. A non-inverting input terminal of an operational amplifier OP receives a reference voltage Vref output by a DAC, an inverting input terminal of the operational amplifier OP is connected to a source of the transistor M0, and an output terminal of the operational amplifier OP is connected to a gate of the transistor M0. The source of the transistor M0 is also connected to a plurality of resistors (Rt1, Rt2, . . . Rtx), and the plurality of resistors are grounded through a plurality of switches (St1, St2, . . . Stx), respectively. By controlling different switches to turn on, different resistors can be connected into the circuit, thereby changing the current flowing through the LED string. Since the resistance values of the resistors are generally low, each switch has an associated impedance which must be taken into account when adjusting the current flowing through the LED string, so that dimming accuracy may be low.

In some other existing linear dimming circuits, the reference voltage at the non-inverting input terminal of the operational amplifier is also used as a dimming signal, and the current flowing through the LED string is controlled by changing the magnitude of the reference voltage. During the dimming process, the offset voltage of the operational amplifier will affect the minimum brightness of the LED string, so the operational amplifier is required to have high precision, which not only results in high cost but also makes it difficult to apply in most dimming circuits. In common linear dimming circuits that achieve LED dimming by adjusting the ratio of a current mirror, as the dimming precision increases, the number of constant current transistors increases exponentially, and the corresponding cost and circuit area also increase exponentially, thereby limiting the improvement of dimming precision, thus the corresponding dimming depth cannot be optimized, and full-range dimming cannot be achieved. Therefore, conventional linear dimming solutions need to be improved.

### SUMMARY OF THE DISCLOSURE

In order to solve the above technical problems, the present application provides an LED dimming circuit, a multi-channel LED dimming system, and a display device to solve problems in the prior art.

According to one aspect of the present disclosure, there is provided an LED dimming circuit connected to an LED string, wherein the LED dimming circuit includes: an operational amplifier, having a non-inverting input terminal configured to receive a reference voltage; and a plurality of dimming branches connected in parallel, wherein each of the plurality of dimming branches includes a switch unit, a first transistor, and a first resistor connected to the first transistor, a common node of the first resistor and the first transistor is connected to an inverting input terminal of the operational amplifier through the switch unit, a control terminal of the first transistor is connected to an output terminal of the operational amplifier through the switch unit, wherein each of the plurality of dimming branches operates in on state when its corresponding switch unit is turned on, and a current flowing through the LED string is adjusted by controlling on/off states of the plurality of dimming branches.

Optionally, a resistance value of the first resistor in a first dimming branch of the plurality of dimming branches is R, and a resistance value of the first resistor in an i-th dimming branch of the plurality of dimming branches is R*2\hat{ }(i−1), where 2≤i≤n and n is a total number of the plurality of dimming branches.

Optionally, by controlling different ones or combinations selected from the plurality of dimming branches to operate in the on state, 2\hat{ }n brightness levels of the LED string are provided, where n is the total number of the plurality of dimming branches.

Optionally, the n switch units are controlled by a binary code or a one-hot code or a combination of the one-hot code and the binary code, so as to correspondingly control the on/off states of the n dimming branches.

Optionally, each switch unit includes: a first switch connected between the control terminal of the first transistor and the output terminal of the operational amplifier; a second switch connected between the common node of the first resistor and the first transistor and the inverting input terminal of the operational amplifier, wherein the first switch and the second switch are turned on and off synchronously.

Optionally, the LED dimming circuit further includes: a second transistor, which is connected in series with the LED string; a PWM driver circuit connected to the control terminal of the second transistor, and configured to provide a PWM signal to the second transistor, and control a duty cycle of the PWM signal provided to the second transistor to adjust the current flowing through the LED string.

Optionally, each switch unit further includes: a third switch connected to the control terminal (e.g., gate) of the first transistor, wherein the third switch is turned on when its corresponding dimming branch operates in off state, so as to discharge a parasitic charge of the first transistor.

Optionally, the reference voltage is generated by a current source and a second resistor which are connected in series, and a voltage across the second resistor serves as the reference voltage.

According to another aspect of the present disclosure, there is provided a multi-channel LED dimming system including: m LED dimming circuits as described above; and m LED strings respectively connected to the m LED dimming circuits, wherein m is greater than or equal to 2.

Optionally, the multi-channel LED dimming system further includes: a reference voltage switching unit including m reference voltage switching branches that are identical and arranged in parallel, wherein when each reference voltage switching branch is connected to any one of the LED dimming circuits, a corresponding reference voltage is generated, wherein within each dimming cycle, each reference voltage switching branch sequentially provides the reference voltage to the m LED dimming circuits, and at any instant, the m reference voltage switching branches separately provide a reference voltage to the m dimming branches in a one-to-one correspondence.

Optionally, each reference voltage switching branch includes a first current source and a switch set connected to the first current source, the switch set includes m selecting switches, which are respectively connected between the first current source and the non-inverting input terminals of the m operational amplifiers.

Optionally, the non-inverting input terminals of the m operational amplifiers are further connected respectively to m second resistors, and a voltage across each of the m second resistors serves as the reference voltage.

Optionally, each dimming cycle includes m switching instants, and the m selecting switches in each reference voltage switching branch turn on in rotation at each switching instant; each one of the m LED dimming circuits is configured to switch a non-repeated one of the m reference voltage switching branches to be connected to the operational amplifier therein at each switching instant.

According to another aspect of the present invention, there is provided a display device including: a display panel including a plurality of LED strings which are lit simultaneously; and a driver circuit including a power supply and the above-mentioned multi-channel LED dimming system.

The beneficial effects of the present disclosure at least include:

The LED dimming circuit, the multi-channel LED dimming system, and the display device according to the present disclosure are provided with multiple dimming branches connected in parallel to the LED string. Each dimming branch includes a first transistor and a first resistor connected in series, and a common node of the first transistor and the first resistor is connected to an inverting input terminal of the operational amplifier through a switch unit. An output terminal of the operational amplifier is also connected to a control terminal of the corresponding first transistor through the switch unit. Therefore, when the corresponding dimming branch is in on state, only the first transistor and the first resistor are incorporated into the current path of the LED string, and the switch unit is arranged outside the current path of the LED string, thereby avoiding the influence of the switch resistance on the dimming current and achieving high dimming accuracy and low error. Moreover, by controlling different dimming branches to operate in on state, dimming at different brightness levels can be achieved. Thus, the dimming range is wide, the cost is low, the circuit occupies a small area, the precision requirement for the operational amplifier is low, and the LED dimming circuit can be applied to most dimming circuits and has strong applicability.

Furthermore, by setting resistance values of the first resistors in the plurality of dimming branches, various dimming solutions can be provided. By controlling different ones or combinations of the dimming branches to operate in on state, full-range linear dimming can be achieved, corresponding to different brightness levels, with good dimming accuracy and high precision. According to circuit requirements, different resistance values of the first resistors can be set, so that the dimming has strong universality. Preferably, the resistance values of the first resistors in the dimming branches are sequentially doubled, so that the switches can be controlled by a binary code, a one-hot code, or a combined code of the two, thereby achieving full-range linear dimming, reducing circuit cost, and improving dimming accuracy.

Furthermore, a PWM driver circuit is provided to drive a second transistor connected to the LED string, so as to implement PWM high-voltage driving for dimming, that is, controlling a duty cycle of the PWM signal to adjust the brightness of the LED string, thereby achieving dimming in different modes and further improving dimming precision.

Furthermore, by using a dedicated current source to provide the reference voltage, the reference voltage is fixed, so that the influence of an offset voltage of the operational amplifier on dimming accuracy can be reduced. In a scenario where a high-precision operational amplifier is adopted, a plurality of different reference current sources can also be used to provide different reference voltages to the operational amplifiers, respectively, thereby achieving full-range linear dimming while increasing dimming diversity.

Furthermore, a reference voltage switching unit is provided in the multi-channel LED dimming system. The reference voltage switching unit includes m identical reference voltage switching branches arranged in parallel. When each reference voltage switching branch is connected to any one of the LED dimming circuits, a corresponding reference voltage is generated. Moreover, at different switching instants of one dimming cycle, each LED dimming circuit sequentially switches different reference voltage switching branches to be connected to its operational amplifier to provide the reference voltage, and the reference voltage switching branches respectively used by multiple LED dimming circuits at any given time are different from each other. That is, within each dimming cycle, each reference voltage switching branch sequentially provides the reference voltage to the m LED dimming circuits, and at any instant, the m reference voltage switching branches separately provide a reference voltage to the m dimming branches in a one-to-one correspondence. Therefore, all the LED dimming circuits can use multiple reference voltage switching branches in turn to provide the reference voltage within each dimming cycle. Even if a current provided by each first current source has a slight deviation due to a manufacturing process or an environmental factor, current balancing can be achieved within each dimming cycle due to the rotation. Thus, the matching degree between channels in the multi-channel LED dimming system can be improved, making the dimming currents generated by the multiple LED dimming circuits consistent; that is, the brightness of the multiple LED strings is balanced, so that the display brightness can be uniformed, reducing flicker and improving display consistency.

It should be understood that the above general description and the following detailed description are merely exemplary and explanatory, and are not intended to limit the present invention.

### BRIEF DESCRIPTION OF THE DRAWINGS

FIG. 1 shows a schematic circuit diagram of an LED dimming circuit in the prior art;

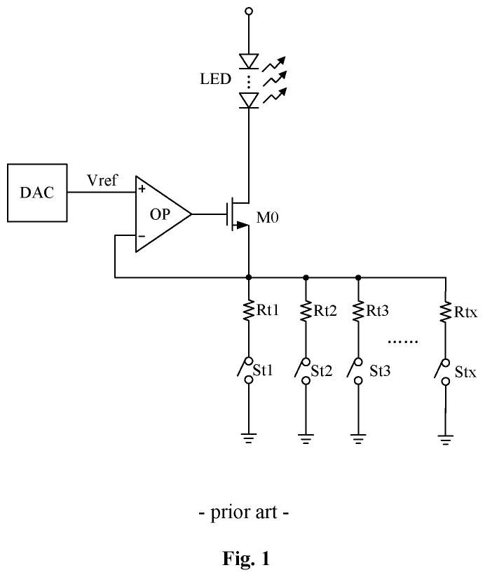

FIG. 2 shows a schematic circuit diagram of an LED dimming circuit according to a first embodiment of the present disclosure;

FIG. 3 shows a schematic circuit diagram of an LED dimming circuit according to a second embodiment of the present disclosure;

FIG. 4 shows a schematic circuit diagram of a multi-channel LED dimming system according to an embodiment of the present disclosure;

FIG. 5 shows a schematic circuit diagram of a three-channel LED dimming system according to an embodiment of the present disclosure.

### DETAILED DESCRIPTION

To facilitate understanding of the present invention, a more comprehensive description of the present invention will now be given below with reference to the relevant drawings. The drawings illustrate preferred embodiments of the present invention. However, the present invention can be implemented in various forms and is not limited to the embodiments described herein. Rather, these embodiments are provided to make the disclosure of the present invention more thorough and comprehensive.

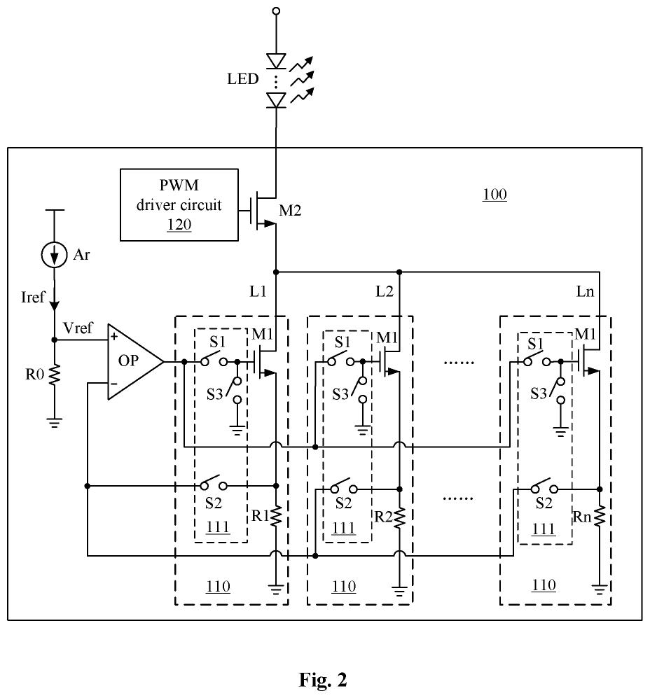

FIG. 2 shows a schematic circuit diagram of an LED dimming circuit according to a first embodiment of the present disclosure.

As shown in FIG. 2, the LED dimming circuit 100 of this embodiment is connected to an LED string including a plurality of LEDs connected in series, wherein the cathode of a preceding LED is connected to the anode of a subsequent LED. The LED dimming circuit 100, for example, is connected to the cathode (or a negative electrode) of the LED string, and the anode of the LED string is configured to receive a power supply voltage provided by a power supply. The LED dimming circuit 100 includes a plurality of dimming branches 110, which are connected in parallel and are each connected to the cathode of the LED string, and an operational amplifier OP. Each dimming branch 110 includes a switch unit 111, a first transistor M1, and a first resistor (e.g., denoted as R1, R2, . . . Rn for different branches) which is connected to the first transistor M1, the drain of the first transistor M1 is connected to the LED string, the source of the first transistor M1 is connected to ground through the first resistor, and the control terminal (gate) of the first transistor M1 is connected to the output terminal of the operational amplifier OP through the switch unit 111. The non-inverting input terminal of the operational amplifier OP is configured to receive a reference voltage Vref, and the inverting input terminal of the operational amplifier OP is connected to a common node of the first resistor and the first transistor M1 in each dimming branch 110 through the corresponding switch unit 111.

When any switch unit 111 controls the corresponding dimming branch 110 to operate in on state and connect to the operational amplifier OP, a current path (L1, L2, . . . Ln) can be provided to the LED string, making the voltages at the non-inverting input terminal and the inverting input terminal of the operational amplifier OP equal, so that the current flowing through the LED string is equal to the ratio of the reference voltage Vref to the resistance value of the first resistor on that path. That is, when any switch unit 111 is turned on, the corresponding dimming branch 110 operates in on state, and the current flowing through the LED string can be adjusted by controlling the on/off states of the plurality of dimming branches 110. Taking each switch unit 111 including a first switch S1 and a second switch S2 as an example, the first switch S1 is connected between the control terminal of the first transistor M1 and the output terminal of the operational amplifier OP, the second switch S2 is connected between the common node of the first resistor and the first transistor M1 and the inverting input terminal of the operational amplifier OP, and the first switch S1 and the second switch S2 are turned on and off synchronously. Then, when the first switch S1 and the second switch S2 in any dimming branch 110 are turned on at the same time, there is a current flowing through that dimming branch 110. When multiple switch units are turned on at the same time, multiple corresponding current paths can be provided to the LED string, and the total current flowing through the LED string is the sum of the currents flowing through those multiple current paths. Since the multiple dimming branches are connected in parallel, different levels of dimming current can be provided when multiple different dimming branches operate in on state at the same time.

Specifically, when a switch unit is turned on, the current magnitude flowing through the corresponding current path is: ILi=Vref/Ri, where i is an integer from 1 to n. Then, when all switch units are turned on at the same time, the total current flowing through the LED string is:

$${I}_{LED} = \frac{Vref}{R 1} + \frac{Vref}{R 2} … … + \frac{Vref}{Rn}$$

Optionally, each switch unit 111 may further include a third switch S3, which is connected between the control terminal of the first transistor M1 and the ground. When a current path is not selected, i.e., the first switch S1 and second switch S2 in the switch unit corresponding to that current path are both turned off, the third switch S3 can be turned on to discharge the parasitic charge on the first transistor M1 and turn off that current path.

Since each current path provided for the LED string includes only the first transistor M1 and the first resistor without any switch, switch resistance is not introduced, and the current on each current path is only equal to the ratio of the reference voltage Vref to the resistance value of the first resistor. Therefore, the LED dimming circuit has high dimming precision, small error, diverse dimming levels, simple circuit structure, low cost, and small footprint. The fixed reference voltage also reduces the precision requirements for the operational amplifier and improves dimming accuracy.

Further, the first resistors in the plurality of dimming branches 110 have identical resistance values, i.e., the resistance values of the first resistors R1, R2, . . . Rn are all the same (for example, all equal to R), so the plurality of dimming branches 110 are completely identical, the currents provided by the plurality of dimming branches 110 are equal, and the number of dimming branches 110 is equal to the number of dimming levels of the current flowing through the LED string. Taking the current on each path as I=Vref/R as an example, each additional dimming branch 110 increases the current by I, and when n dimming branches 110 are in on state at the same time, the current is n times I, so the number of dimming levels is equal to the number of dimming branches 110. In this case, a large number of dimming branches 110 need to be connected in parallel to achieve full-range dimming.

Further, the resistance values of the first resistors in the plurality of dimming branches 110 are not completely identical, and by controlling different ones or combinations selected from the plurality of dimming branches 110 to operate in on state, currents at different dimming levels can be provided to the LED string. For example, the resistance values of some first resistors are identical, and the resistance values of the other first resistors are all different. Alternatively, the resistance values of the first resistors in the plurality of dimming branches 110 can also be all different.

In an optional embodiment, the resistance value of the first resistor in the first dimming branch is R, and the resistance value of the first resistor in the i-th dimming branch is R*2\hat{ }(i−1), where 2≤i≤n. Then, starting from the second dimming branch, the resistance value of the first resistor in each dimming branch is twice that of the first resistor in a preceding dimming branch. For example, in an order from left to right in the figure, the resistance value of the first resistor R1 in the first dimming branch 110 is R, then the resistance value of the first resistor R2 in the second dimming branch 110 is 2R, and so on, the resistance value of the first resistor R3 is 4R, the resistance value of the first resistor R4 is 8R . . . the resistance value of the first resistor Rn is 2\hat{ }(n−1)*R, then the current I1 flowing through the current path L1 is I1=Vref/R, the current flowing through the current path L2 is half of I1, the current flowing through the current path L3 is one quarter of I1, and the current flowing through the current path Ln is I1/[2\hat{ }(n−1)]. Thus, by controlling different ones or combinations selected from the plurality of dimming branches 110 to operate in on state, 2\hat{ }n brightness levels or dimming levels can be provided to the LED string, where n is the total number of the dimming branches 110. For example, n-bit binary code can be used to control n switch units, so as to correspondingly control the on/off states of n dimming branches 110. For example, one-hot code or a combination of a one-hot code and a binary code can also be used to control n switch units, so as to correspondingly control the on/off states of n dimming branches 110. Specifically, for example, a binary code is used to control the n switch units, when n is 8, there can be 256 dimming levels, and full-range linear dimming can be achieved with an 8-bit binary code. For example, when a binary number in the binary code is 1, the corresponding switch unit 111 is turned on (i.e., the first switch S1 and second switch S2 in the switch unit are turned on, and the third switch S3 is turned off), and when the binary number of the binary code is 0, the corresponding switch unit 111 is turned off (i.e., the first switch S1 and second switch S2 in the switch unit are both turned off, and the third switch S3 is turned on). In a feasible embodiment, when the 8-bit binary code is 11111111, all dimming branches operate in on state, and the total current flowing through the corresponding LED string is:

$${I}_{LED} = \frac{Vref}{R} + \frac{Vref}{2 R} … … + \frac{Vref}{128 R}$$

With continued reference to FIG. 2, in this embodiment, the LED dimming circuit 100 further includes a second transistor M2 and a PWM driver circuit 120. The second transistor M2 may be a high-voltage transistor, and is connected between the LED string and the first transistor M1. The PWM driver circuit 120 is connected to the control terminal of the second transistor M2 to provide a PWM signal to the second transistor M2 and control the second transistor M2 to be turned on and off. Thus, the duty cycle for turning on the second transistor M2 can be controlled according to the PWM signal to adjust the current flowing through the LED string, achieving PWM dimming. During PWM dimming, the reference voltage Vref at the non-inverting input terminal of the operational amplifier OP is fixed, and the PWM signal is configured to control the corresponding current path, which is connected to the LED string, to be turned on and off by switching the second transistor M2 on and off, thereby achieving PWM dimming.

In this embodiment, a dedicated current source Ar may be used to provide the reference voltage Vref to the non-inverting input terminal of the operational amplifier OP through a second resistor R0. The dedicated current source Ar is configured to provide a reference current Iref, and has an output terminal connected to a first end of the second resistor R0, a second end of the second resistor R0 is grounded, and the reference voltage Vref is provided at a common node of the dedicated current source Ar and the second resistor R0, thereby reducing the precision requirements for the operational amplifier OP.

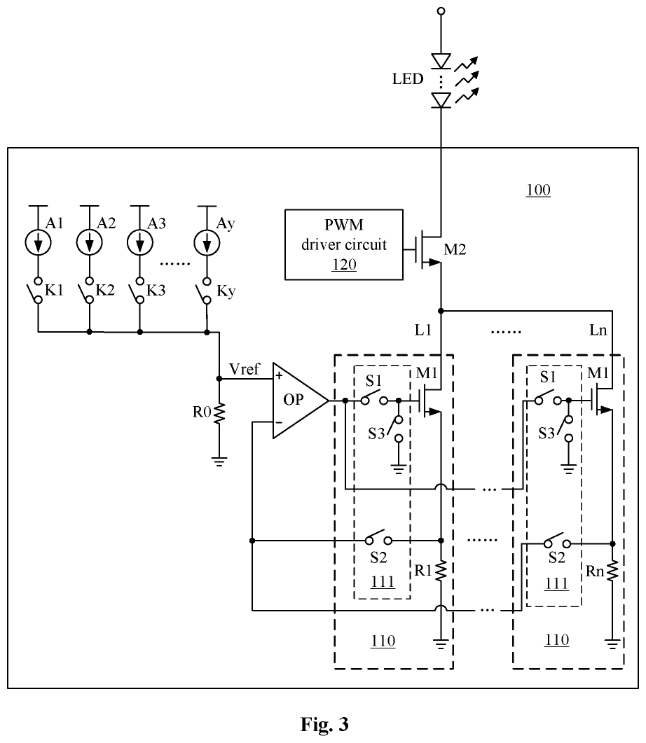

FIG. 3 shows a schematic circuit diagram of an LED dimming circuit according to a second embodiment of the present disclosure.

As shown in FIG. 3, the LED dimming circuit 100 according to this embodiment is almost identical to the dimming circuit 100 according to the embodiment as shown in FIG. 2, except that multiple reference current sources are provided in this embodiment. That is, the LED dimming circuit 100 includes a plurality of dimming branches 110 connected in parallel, an operational amplifier OP, a second transistor M2, a PWM driver circuit 120, and a second resistor R0. The description of the same parts as those in FIG. 2 is omitted herein. In addition, the LED dimming circuit 100 further includes multiple reference current sources (A1, A2, A3, . . . Ay) and corresponding multiple control switches (K1, K2, . . . Ky). A common node between the second resistor R0 and the multiple reference current sources is connected to the non-inverting input terminal of the operational amplifier OP. By controlling different reference current sources to be connected to the second resistor R0, different reference voltages Vref can be provided. In this embodiment, the currents provided by the multiple reference current sources are, for example, all different. By turning on different control switches to connect different reference current sources into the circuit, the non-inverting input terminal of the operational amplifier OP can receive the reference voltage Vref with different amplitudes, thereby generating different current references suitable for different scenarios. Alternatively, if a high-precision operational amplifier OP is provided in the circuit, one or several dimming branches 110 may remain in on state, and linear dimming can be thereby achieved by switching the reference current sources.

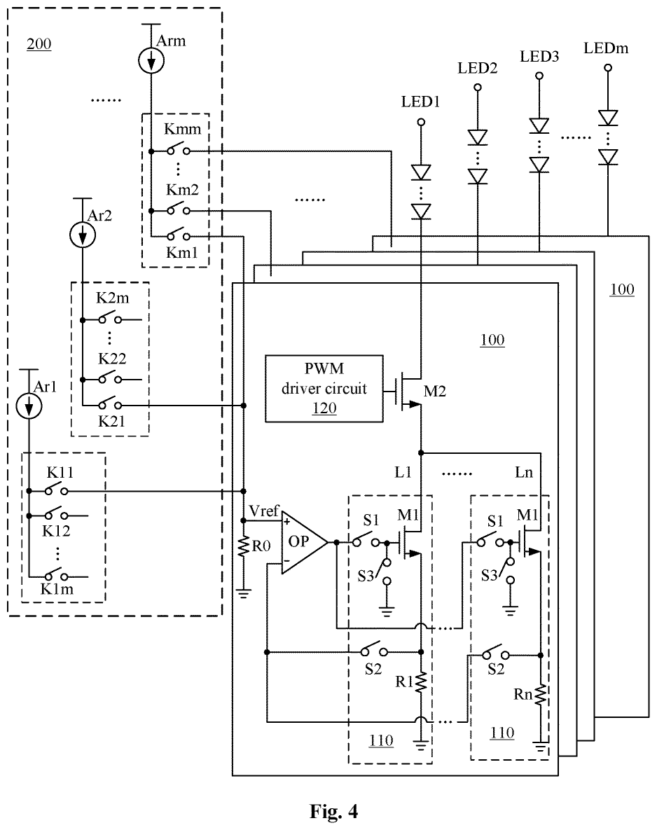

FIG. 4 shows a schematic circuit diagram of a multi-channel LED dimming system according to an embodiment of the present disclosure.

This embodiment further provides a multi-channel LED dimming system, which includes a plurality of LED strings and a plurality of LED dimming circuits 100. Each LED string is connected to a corresponding one of the plurality of LED dimming circuits 100, thereby achieving simultaneous dimming on multiple channels. Each LED dimming circuit 100 can be implemented by the circuit as shown in FIG. 2 or FIG. 3. During each dimming operation, the current sources used in the plurality of LED dimming circuits 100 are all the same, and the dimming branches 110 that operate in on state are also the same, so that the brightness of each LED string is the same, and the overall brightness is consistent and uniform.

In order to achieve uniform brightness of the multi-channel LED dimming system, the reference voltage Vref for each channel is set to be equal, so that each channel has equal LED current and uniform brightness. However, due to process differences, environmental differences, or the like, parameters of the current sources in the same batch may deviate to a certain extent, leading to deviations among the provided reference voltages, which ultimately causes deviations among the currents flowing through the LED strings in the multiple channels, resulting in non-uniform brightness. To solve this problem, a reference voltage switching unit 200 is provided in the multi-channel LED dimming system in this embodiment. Specifically, as shown in FIG. 4, the multi-channel LED dimming system includes m aforementioned LED dimming circuits and m LED strings, as well as a reference voltage switching unit 200. The m LED strings are respectively connected to the m LED dimming circuits, where m is greater than or equal to 2. The reference voltage switching unit 200 includes m reference voltage switching branches which are identical and arranged in parallel, and when each reference voltage switching branch is connected to any one of the LED dimming circuits, the corresponding reference voltage Vref is generated. At any time, the m reference voltage switching branches are respectively connected to the operational amplifiers in the m LED dimming circuits 100, in order to provide the corresponding reference voltages Vref. Within a dimming cycle, each reference voltage switching branch is sequentially connected to the m operational amplifiers to provide the corresponding reference voltages Vref.

Each reference voltage switching branch includes a first current source (Ar1, Ar2, . . . Arm) and a switch set connected to the first current source. The switch set includes m selecting switches (Ki1, Ki2, . . . Kim, where 1≤i≤m), and the m selecting switches are respectively connected between the same first current source and the non-inverting input terminals of the m operational amplifiers. Moreover, the non-inverting input terminals of the m operational amplifiers are also respectively connected to m second resistors R0, and the voltage across each second resistor R0 serves as the corresponding reference voltage Vref. Then, when any selecting switch in the switch set corresponding to any first current source is turned on, the corresponding LED dimming circuit is connected to the first current source which is connected to that turned-on selecting switch, so the first current source can be connected through the turned-on selecting switch to the first end of the corresponding second resistor R0, and the second end of that second resistor R0 is grounded. The common node of the turned-on selecting switch and the second resistor R0 is connected to the non-inverting input terminal of the corresponding operational amplifier OP to provide the reference voltage Vref. Therefore, turning on any selecting switch can connect the first current source, which is connected to that turned on selecting switch, to the corresponding LED dimming circuit. The reference voltage switching unit 200 in this embodiment includes multiple first current sources which are identical, but differences due to processing, environment, or the like, may still exist, that is, the multiple first current sources may not be exactly the same due to mismatching.

Furthermore, the dimming cycle includes m switching instants, and each LED dimming circuit 100 is configured to switch to a non-repeated one of the reference voltage switching branches at each switching instant in the dimming cycle, so that the operational amplifier included in that LED dimming circuit 100 can be connected to that non-repeated one of the reference voltage switching branches. That is, the m selecting switches in each reference voltage switching branch turn on in rotation at each switching instant. At different switching instants, different first current sources are connected to the second resistor R0 in each LED dimming circuit 100 to provide the reference voltage Vref, and at the same switching instant, the first current sources connected to different ones of the plurality of LED dimming circuits 100 are at different sequence positions. As an example, at a given time, if one LED dimming circuit uses the first current source Ar1, then another LED dimming circuit cannot use that first current source Ar1, and instead uses any one or a specific one selected from the first current sources Ar2 to Arm, and so on for the remaining LED dimming circuit(s). Furthermore, the LED strings may operate in multiple dimming cycles, that is, the m first current sources in the reference voltage switching unit 200 supply the corresponding reference voltage in rotation to each LED dimming circuit for multiple rounds. In this way, the same reference voltage Vref can be provided to the LED string of each channel.

In one dimming cycle, all of the first current sources in the reference voltage switching unit 200 can take turns to provide the same reference voltage Vref to each LED dimming circuit. In this way, after one or more dimming cycles, an average value of the reference voltage Vref received by each LED dimming circuit 100 is the same, which can be approximated as a fixed value, thereby achieving dimming with uniform brightness, and each LED string can have the same current and the same brightness.

Referring again to FIG. 4, the reference voltage switching unit 200 includes multiple reference voltage switching branches, each reference voltage switching branch includes a first current source and a corresponding switch set. According to the order from left to right in the figure as a sequential order of the m first current sources, the first reference voltage switching branch includes the first current source Ar1 and the first switch set, the first switch set includes selecting switches K11, K12, . . . K1m, the selecting switch K11 is connected between the first current source Ar1 and the second resistor of the first LED dimming circuit, the selecting switch K12 is connected between the first current source Art and the second resistor of the second LED dimming circuit, . . . the selecting switch K1m is connected between the first current source Art and the second resistor of the m-th LED dimming circuit; similarly, the second reference current switching branch includes the first current source Ar2 and the second switch set, the second switch set includes selecting switches K21, K22, . . . K2m, and the selecting switches K21, K22, . . . K2m are respectively connected between the first current source Ar2 and the second resistors of the first LED dimming circuit to the m-th LED dimming circuit; and so forth, the description of which is omitted herein.

At each switching instant, the first current sources are sequentially switched to be connected to the respective LED dimming circuits 100 according to the sequential order of the first current sources. As an example, one dimming cycle includes m switching instants. At a first switching instant: the selecting switch K11 is turned on, and the first LED dimming circuit 100 is connected to the first current source Ar1; simultaneously, the selecting switch K22 is turned on, and the second LED dimming circuit 100 is connected to the first current source Ar2; simultaneously, the selecting switch K33 is turned on, and the third LED dimming circuit 100 is connected to the first current source Ar3; . . . simultaneously, the selecting switch Kmm is turned on, and the m-th LED dimming circuit 100 is connected to the first current source Arm. At the second switching instant: the selecting switch K21 is turned on, and the first LED dimming circuit 100 is connected to the first current source Ar2; simultaneously, the selecting switch K32 is turned on, and the second LED dimming circuit 100 is connected to the first current source Ar3; simultaneously, the selecting switch K43 is turned on, and the third LED dimming circuit 100 is connected to the first current source Ar4; . . . simultaneously, the selecting switch K1m is turned on, and the m-th LED dimming circuit 100 is connected to the first current source Ar1, and so on.

Alternatively, it is also possible to rotate in a reverse order of the sequential order. For example, at the first switching instant, the selecting switch K11 is turned on, and the first LED dimming circuit 100 is connected to the first current source Ar1; simultaneously, the selecting switch K22 is turned on, and the second LED dimming circuit 100 is connected to the first current source Ar2; . . . simultaneously, the selecting switch Kmm is turned on, and the m-th LED dimming circuit 100 is connected to the first current source Arm. At the second switching instant, the selecting switch Km1 is turned on, and the first LED dimming circuit 100 is connected to the first current source Arm; simultaneously, the selecting switch K12 is turned on, and the second LED dimming circuit 100 selects the first current source Ar1; . . . simultaneously, the selecting switch K(m−1)m is turned on, and the m-th LED dimming circuit 100 selects the first current source Ar(m−1), and so on.

Therefore, after one or more rounds of rotation for supplying the reference voltage, the average value of the reference voltage Vref in one dimming cycle is:

$$Vref 0 = \frac{( Ar 1 + Ar 2 + … + Arm ) \times R 0}{m}$$

Thus, the average value of the reference voltage Vref in each channel from the LED string LED1 to the LED string LEDm is equal.

Therefore, in this embodiment, each of the plurality of LED dimming circuits can use multiple first current sources in turn to provide the reference voltage within each dimming cycle, thereby achieving current balancing among multiple channels within one dimming cycle. Thus, the matching degree among channels in the multi-channel LED dimming system can be improved, making the dimming currents generated by multiple LED dimming circuits consistent, that is, the brightness of the multiple LED strings is balanced, so that the display brightness is uniform, flicker perceived by the human eye is reduced, and display consistency is improved.

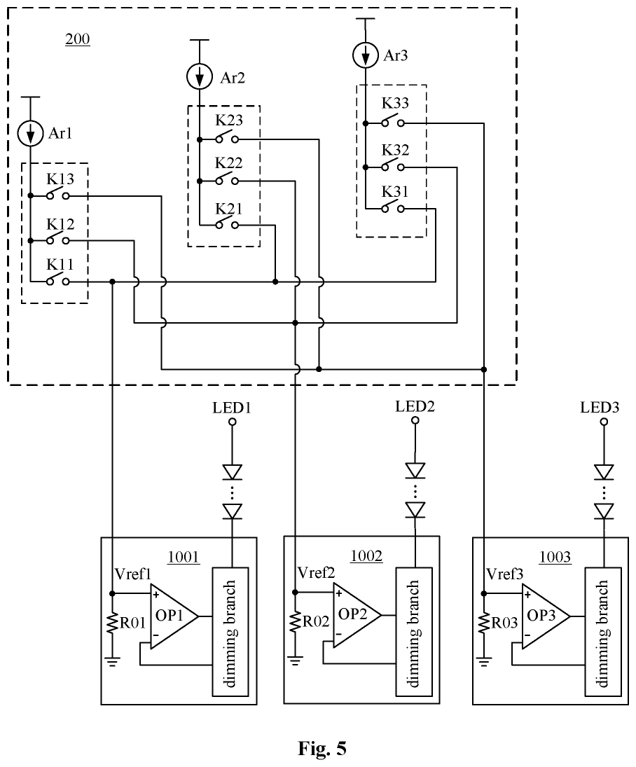

FIG. 5 shows a schematic circuit diagram of a three-channel LED dimming system according to an embodiment of the present disclosure. FIG. 5 is a specific embodiment of FIG. 4, taking three channels as an example. As shown in FIG. 5, the reference voltage switching unit 200 includes 3 reference voltage switching branches. The first reference voltage switching branch includes a first current source Ar1 and a switch set (including selecting switches K11, K12, and K13), the second reference voltage switching branch includes a first current source Ar2 and a switch set (including selecting switches K21, K22, and K23), and the third reference voltage switching branch includes a first current source Ar3 and a switch set (including selecting switches K31, K32, and K33). The three-channel LED dimming system includes 3 LED dimming circuits, namely LED dimming circuit 1001, LED dimming circuit 1002, and LED dimming circuit 1003. The LED dimming circuit 1001 includes an operational amplifier OP1 and a corresponding dimming branch. The non-inverting input terminal of the operational amplifier OP1 is grounded through a second resistor R01 and is also connected to the 3 reference voltage switching branches, the common node of the second resistor R01 and the reference voltage switching branches is configured to provide a reference voltage Vref1. Similarly, the LED dimming circuit 1002 includes an operational amplifier OP2 and a corresponding dimming branch. The non-inverting input terminal of operational amplifier OP2 is grounded through a second resistor R02 and is also connected to the 3 reference voltage switching branches, the common node of the second resistor R02 and the reference voltage switching branches is configured to provide a reference voltage Vref2. The LED dimming circuit 1003 includes an operational amplifier OP3 and a corresponding LED dimming branch. The non-inverting input terminal of the operational amplifier OP3 is grounded through a second resistor R03 and is also connected to the 3 reference voltage switching branches, and the common node of the second resistor R03 and the reference voltage switching branches is configured to provide a reference voltage Vref3.

As an example, a workflow of the reference voltage switching unit 200 in this embodiment is described as follows: each dimming cycle includes 3 switching instants; at the first switching instant, the selecting switches K11, K22, and K33 are turned on simultaneously, the first current source Ar1 is connected to the second resistor R01 through the selecting switch K11 to allow the reference voltage Vref1 to be provided to the operational amplifier OP1, the first current source Ar2 is connected to the second resistor R02 through the selecting switch K22 to allow the reference voltage Vref2 to be provided to the operational amplifier OP2, and the first current source Ar3 is connected to the second resistor R03 through the selecting switch K33 to allow the reference voltage Vref3 to be provided to the operational amplifier OP3; at the second switching instant, the selecting switches K21, K32, and K13 are turned on simultaneously, the first current source Ar2 is connected to the second resistor R01 through the selecting switch K21 to allow the reference voltage Vref1 to be provided to the operational amplifier OP1, the first current source Ar3 is connected to the second resistor R02 through the selecting switch K32 to allow the reference voltage Vref2 to be provided to the operational amplifier OP2, and the first current source Ar1 is connected to the second resistor R03 through the selecting switch K13 to allow the reference voltage Vref3 to be provided to the operational amplifier OP3; at the third switching instant, the selecting switches K31, K12, and K23 are turned on simultaneously, the first current source Ar3 is connected to the second resistor R01 through the selecting switch K31 to allow the reference voltage Vref1 to be provided to the operational amplifier OP1, the first current source Ar1 is connected to the second resistor R02 through the selecting switch K12 to allow the reference voltage Vref2 to be provided to the operational amplifier OP2, and the first current source Ar2 is connected to the second resistor R03 through the selecting switch K23 to allow the reference voltage Vref3 to be provided to the operational amplifier OP3. Therefore, in this dimming cycle, the operational amplifier OP1 is connected to the first current sources Ar1, Ar2, and Ar3 in turn, the operational amplifier OP2 is connected to the first current sources Ar2, Ar3, and Ar1 in turn, and the operational amplifier OP3 is connected to the first current sources Ar3, Ar1, and Ar2 in turn. The three first current sources in the reference voltage switching unit 200 are each used for generating the reference voltage once in turn, so in this dimming cycle, the currents generated on the three LED dimming circuits are the same. Therefore, after multiple dimming cycles, the brightness of the LED strings in the three channels is the same, achieving uniform image display.

Furthermore, in the embodiment of the present disclosure, the m second resistors can be integrated one-to-one with the m operational amplifiers respectively, that is, each LED dimming circuit can be provided with one second resistor integrated therein. In some other embodiments, the m second resistors can also be all integrated together with the reference voltage switching unit 200, that is, the m second resistors may all be located outside the LED dimming circuits, and each second resistor can be connected below a corresponding one of the first current sources, with the common node of the two connected to the switch set.

In addition, the present application also provides a display device. The display device includes a display panel and a driver circuit. The display panel may include a plurality of LED strings which can be lit simultaneously, and correspondingly, the driver circuit includes a power supply and the multi-channel LED dimming system according to the embodiment as shown in FIG. 4. The power supply is configured to provide a power supply voltage to the plurality of LED strings. The power supply is, for example, a switching power supply, which provides an output voltage to an anode or a positive electrode of each LED string, while the multi-channel LED dimming system is connected to a cathode or a negative electrode of each LED string, thereby achieving balanced image display.

In summary, the LED dimming circuit, the multi-channel LED dimming system, and the display device according to the embodiments of the present disclosure are provided with multiple dimming branches, which are connected to the LED string and connected in parallel. Each dimming branch includes a first transistor and a first resistor connected in series, and the common node of the first transistor and the first resistor is connected to the inverting input terminal of the operational amplifier through a switch unit. The output terminal of the operational amplifier is also connected to the control terminal of each first transistor through the corresponding switch unit. Therefore, when the corresponding dimming branch is in on state, only the first transistor and the first resistor are incorporated into the current path for the LED string, and the switch is arranged outside the current path for the LED string, avoiding the influence of the switch resistance on the dimming current, achieving high dimming accuracy and low error. Moreover, by adjusting the resistance value of the first resistor in each dimming branch and cooperating with selecting different combinations from the dimming branches to operate in on state, dimming at different brightness levels can be achieved. Thus, the dimming range is wide, the cost is low, the circuit occupies a small area, the precision requirement for the operational amplifier is low, and the LED dimming circuit can be applied to most dimming circuits and has strong applicability.

Furthermore, a reference voltage switching unit is provided in the multi-channel LED dimming system. The reference voltage switching unit includes m identical reference voltage switching branches arranged in parallel. When each reference voltage switching branch is connected to any one of the LED dimming circuits, a corresponding reference voltage is generated. Moreover, at different switching instants of one dimming cycle, each LED dimming circuit sequentially switches different reference voltage switching branches to be connected to its operational amplifier to provide the reference voltage, and the reference voltage switching branches respectively used by multiple LED dimming circuits at any given time are different from each other. Therefore, each LED dimming circuit can use multiple reference voltage switching branches in turn to provide its reference voltage within each dimming cycle, achieving current balancing on multiple LED strings within one dimming cycle. Thus, the matching degree between channels in the multi-channel LED dimming system can be improved, making the dimming currents generated by multiple LED dimming circuits consistent, that is, the brightness of multiple LED strings is balanced, so that the display brightness can be balanced, reducing flicker and improving display consistency.

It should be noted that the numerical values herein are merely exemplary. In some other embodiments of the present invention, other numerical values may also be adopted to implement the present solution. Specifically, the values should be reasonably set according to actual conditions, and the present invention is not limited thereto.

Finally, it should be understood that the foregoing embodiments are merely illustrative and are not intended to limit the embodiments of the present invention. Those of ordinary skill in the art may also make other changes or variations in different forms based on the foregoing description. It is neither necessary nor possible to exhaustively enumerate all embodiments herein. Any obvious changes or variations resulting therefrom fall within the scope of the present invention.

It should also be understood that the terms and expressions used herein are for descriptive purposes only and are not intended as limitations. The use of such terms and expressions is not intended to exclude any equivalents of the features shown and described (or portions thereof). It should be recognized that various modifications may be made and are also included within the scope of the appended claims. Other modifications, variations, and substitutions are also possible. Accordingly, the appended claims are intended to cover all such equivalents.

What is claimed is:

1. An LED dimming circuit connected to an LED string, wherein the LED dimming circuit comprises:
an operational amplifier, having a non-inverting input terminal configured to receive a reference voltage; and
a plurality of dimming branches connected in parallel, each of which comprises a switch unit, a first transistor, and a first resistor connected to the first transistor, wherein a common node of the first resistor and the first transistor is connected to an inverting input terminal of the operational amplifier through the switch unit, a control terminal of the first transistor is connected to an output terminal of the operational amplifier through the switch unit,
wherein when the switch unit is turned on, a corresponding one of the plurality of dimming branches operates in on state, and by controlling on/off states of the plurality of dimming branches, a current flowing through the LED string is adjusted.

2. The LED dimming circuit according to claim 1, wherein a resistance value of the first resistor in a first one of the plurality of dimming branches is R, and a resistance value of the first resistor in an i-th one of the plurality of dimming branches is R*2\hat{ }(i−1), where 2≤i≤n and n is a total number of the plurality of dimming branches.

3. The LED dimming circuit according to claim 2, wherein by controlling different combinations selected from the plurality of dimming branches to operate in on state, 2\hat{ }n brightness levels are provided for the LED string.

4. The LED dimming circuit according to claim 3, wherein the n switch units are controlled by a binary code, a one-hot code, or a combination of the one-hot code and the binary code to correspondingly control the on/off states of the n dimming branches.

5. The LED dimming circuit according to claim 1, wherein each switch unit comprises:
a first switch, which is connected between the control terminal of the first transistor and the output terminal of the operational amplifier;
a second switch, which is connected between the inverting input terminal of the operational amplifier and the common node of the first resistor and the first transistor,
wherein the first switch and the second switch are turned on and off synchronously.

6. The LED dimming circuit according to claim 1, further comprising:
a second transistor, which is connected in series with the LED string;
a PWM driver circuit, which is connected to a control terminal of the second transistor to provide a PWM signal to the second transistor, and is configured to control a duty cycle of the PWM signal to adjust the current flowing through the LED string.

7. The LED dimming circuit according to claim 1, wherein each switch unit comprises:
a third switch, which is connected to the control terminal of the first transistor, and is configured to be turned on to discharge a parasitic charge of the first transistor when a corresponding one of the plurality of dimming branches is in off state.

8. The LED dimming circuit according to claim 1, wherein the reference voltage is generated by a current source and a second resistor which are connected in series, and a voltage across the second resistor serves as the reference voltage.

9. A multi-channel LED dimming system comprising:
m LED dimming circuits each according to claim 1; and
m LED strings respectively connected to the m LED dimming circuits, wherein m is greater than or equal to 2.

10. The multi-channel LED dimming system according to claim 9, further comprising:
a reference voltage switching unit comprising m reference voltage switching branches that are identical and are arranged in parallel, wherein when each reference voltage switching branch is connected to any one of the m LED dimming circuits, the reference voltage is generated correspondingly,
wherein within each dimming cycle, each reference voltage switching branch sequentially provides the reference voltage to the m LED dimming circuits, and at any instant, the m reference voltage switching branches separately provide a reference voltage to the m dimming branches in a one-to-one correspondence.

11. The multi-channel LED dimming system according to claim 10, wherein each of the m reference voltage switching branches comprises a first current source and a switch set connected to the first current source; the switch set comprises m selecting switches, which are respectively connected between the first current source and the non-inverting input terminals of the m operational amplifiers.

12. The multi-channel LED dimming system according to claim 11, wherein the non-inverting input terminals of the m operational amplifiers are further connected to m second resistors, respectively, and a voltage across each of the m second resistors serves as the reference voltage.

13. The multi-channel LED dimming system according to claim 11, wherein each dimming cycle includes m switching instants, the m selecting switches in each reference voltage switching branch turn on in rotation at each switching instant.

14. A display device comprising:
a display panel comprising a plurality of LED strings which are lit simultaneously; and
a driver circuit comprising a power supply and the multi-channel LED dimming system according to claim 9.
